(19) United States
(12) Patent Application Publication
(10) Pub. No.: US 2014/0289334 A1
(43) Pub. Date: Sep. 25, 2014

(54) SYSTEM AND METHOD FOR RECOMMENDING MULTIMEDIA INFORMATION

(71) Applicant: TENCENT TECHNOLOGY (SHENZHEN) COMPANY LIMITED, Shenzhen (CN)

(72) Inventors: Zhi Wang, Shenzhen (CN); Wenwu Zhu, Shenzhen (CN); Lifeng Sun, Shenzhen (CN); Shiqiang Yang, Shenzhen (CN)

(73) Assignee: Tencent Technology (Shenzhen) Company Limited

(21) Appl. No.: 14/297,215

(22) Filed: Jun. 5, 2014

Related U.S. Application Data
(63) Continuation of application No. PCT/CN2013/088958, filed on Dec. 10, 2013.

(30) Foreign Application Priority Data
Mar. 6, 2013 (CN) 201310069990.X

(51) Int. Cl. H04L 29/06; H04N 21/25; H04L 29/08

(52) U.S. Cl. CPC H04L 65/4069; H04L 67/142; H04L 67/141; H04N 21/251
USPC 709/204

(57) ABSTRACT

A method for recommending multimedia information includes obtaining an instant user-multimedia connection set; determining relevance indexes between the users and the multimedia information according to the obtained instant user-multimedia connection set; recommending the multimedia information to the users related to the multimedia information according to the determined relevance index. The invention improves an accuracy of multimedia information recommendation. The invention further provides a system for recommending multimedia information.

### CROSS REFERENCE TO RELATED APPLICATIONS

The present application is a continuation application of PCT Patent Application No. PCT/CN2013/088958, filed on Dec. 10, 2013, which claims the benefit of priority to China patent application NO. 201310069990.X filed in the Chinese Patent Office on Mar. 6, 2013 and entitled “SYSTEM AND METHOD FOR RECOMMENDING MULTIMEDIA INFORMATION”, the content of which is hereby incorporated by reference in its entirety.

### FIELD OF THE TECHNICAL

The disclosure relates to the computer field, and particularly to a system and method for recommending multimedia information.

### BACKGROUND

The section provides background information related to the present disclosure which is not necessarily prior art.

With the rapid development of network technology, more and more multimedia information such as videos appears on social networks. Moreover, many social network services allow users to import and re-share the videos (namely user-generated videos) through the social connections. Therefore, a large number of videos are available to users in the social networks. The rapid growth of user-generated videos provides enormous potential for user to find the ones that interest them. However, it is difficult for the user to find their preference videos from the large number of videos in a short time.

### SUMMARY

The disclosed information recommend method and device are directed to solve one or more problems set forth above and other problems.

This section provides a general summary of the disclosure, and is not a comprehensive disclosure of its full scope or all of its features.

Further areas of applicability will become apparent from the description provided herein. The description and specific examples in this summary are intended for purposes of illustration only and are not intended to limit the scope of the present disclosure.

A method for recommending multimedia information comprising:

obtaining an instant user-multimedia connection set;

determining relevance indexes between the users and the multimedia information according to the obtained instant user-multimedia connection set;

recommending the multimedia information to the users related to the multimedia information according to the determined relevance index.

A system for recommending multimedia information comprising:

an obtaining module configured to obtain an instant user-multimedia connection set;

a determination module configured to determine relevance indexes between the users and the multimedia information according to the obtained instant user-multimedia connection set;

a recommend module configured to recommend the multimedia information to the users related to the multimedia information according to the determined relevance indexes.

### BRIEF DESCRIPTION OF THE DRAWINGS

In order to illustrate the embodiments or existing technical solutions more clearly, a brief description of drawings that assists the description of embodiments of the invention or existing art will be provided below. It would be apparent that the drawings in the following description are only for some of the embodiments of the invention. A person having ordinary skills in the art will be able to obtain other drawings on the basis of these drawings without paying any creative work.

FIG. 1 is a flowchart of an example of a method for recommending multimedia information according to various embodiments;

FIG. 2 is a flowchart of a second step of FIG. 1;

FIG. 3 is a flowchart of a second step of FIG. 2;

FIG. 4 is a flowchart of a third step of FIG. 2;

FIG. 5 is a flowchart of a fourth step of FIG. 2;

FIG. 6 is a flowchart of a fifth step of FIG. 2;

FIG. 7 is a flowchart of another example of a method for recommending multimedia information according to various embodiments;

FIG. 8 is a flowchart of a second step of FIG. 7;

FIG. 9 is a block diagram of an example of a system for recommending multimedia information according to various embodiments, the system including a determination module;

FIG. 10 is a block diagram of the determination module of FIG. 9, the determination module including a first determination unit;

FIG. 11 is a block diagram of the first determination unit of FIG. 10.

FIG. 12 is a block diagram of another example of a system for recommending multimedia information according to various embodiments, the system including an update module;

FIG. 13 is a block diagram of the update module of FIG. 12;

FIG. 14 depicts an exemplary environment incorporating certain disclosed embodiments; and

FIG. 15 depicts an exemplary computing system consistent with the disclosed embodiments.

### DETAILED DESCRIPTION OF ILLUSTRATED EMBODIMENTS

Technical solutions in embodiments of the present invention will be illustrated clearly and entirely with the aid of the drawings in the embodiments of the invention. It is apparent that the illustrated embodiments are only some embodiments of the invention instead of all of them. Other embodiments that a person having ordinary skills in the art obtains based on the illustrated embodiments of the invention without paying any creative work should all be within the protection scope sought by the present invention.

FIG. 14 depicts an exemplary environment 600 incorporating exemplary methods and systems for recommending multimedia information in accordance with various disclosed embodiments. As shown in FIG. 14, the environment 600 can include a server 604, a terminal 606, and a communication network 602. The server 604 and the terminal 606 may be coupled through the communication network 602 for information exchange including, e.g., sending/receive multimedia information, obtaining instant user-multimedia connection set, recommending multimedia information, etc. Although only one terminal 606 and one server 604 are shown in the environment 600, any number of terminals 606 or servers 604 may be included, and other devices may also be included.

The communication network 602 may include any appropriate type of communication network for providing network connections to the server 604 and terminal 606 or among multiple servers 604 or terminals 606. For example, the communication network 602 may include the Internet or other types of computer networks or telecommunication networks, either wired or wireless.

A terminal, as used herein, may refer to any appropriate user terminal with certain computing capabilities, e.g. a personal computer (PC), a work station computer, a hand-held computing device (e.g., a tablet), a mobile terminal (e.g., a mobile phone or a smart phone), or any other client-side computing device.

A server, as used herein, may refer to one or more server computers configured to provide certain server functionalities, e.g., receiving multimedia information, connection set obtaining, connection set processing, recommending multimedia information for users, etc. A server may also include one or more processors to execute computer programs in parallel.

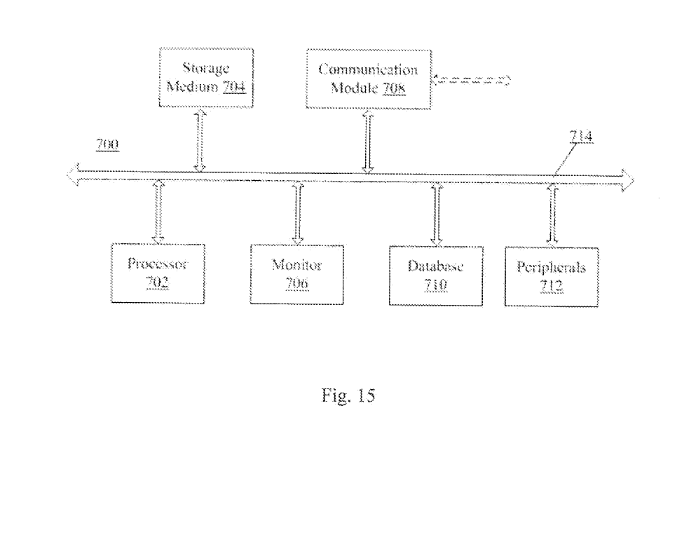

The server 604 and the terminal 606 may be implemented on any appropriate computing platform. FIG. 15 shows a block diagram of an exemplary computing system 700 (or computer system 700) capable of implementing the server 604 and/or the terminal 606. As shown in FIG. 15, the exemplary computer system 700 may include a processor 702, a storage medium 704, a monitor 706, a communication module 708, a database 710, peripherals 712, and one or more bus 714 to couple the devices together. Certain devices may be omitted and other devices may be included.

The processor 702 can include any appropriate processor or processors. Further, the processor 702 can include multiple cores for multi-thread or parallel processing. The storage medium 704 may include memory modules, e.g., Read-Only Memory (ROM), Random Access Memory (RAM), and flash memory modules, and mass storages, e.g., CD-ROM, U-disk, removable hard disk, etc. The storage medium 704 may store computer programs for implementing various processes (e.g., receiving multimedia information, processing multimedia information, etc.), when executed by the processor 702.

The monitor 706 may include display devices for displaying contents in the computing system 700, e.g., displaying recommended multimedia information or multimedia information interface. The peripherals 712 may include I/O devices such as keyboard and mouse.

Further, the communication module 708 may include network devices for establishing connections through the communication network 602. The database 710 may include one or more databases for storing certain data and for performing certain operations on the stored data, e.g., storing connection sets, user IDs, and determined relevance index between users and multimedia information, or any other suitable data searching and management operations.

In operation, the terminal 606 may cause the server 604 to perform certain actions, e.g., receiving multimedia information from a user terminal, returning recommended multimedia information, etc. The server 604 may be configured to provide structures and functions for such actions and operations. More particularly, the server 604 may include a management server, a messaging server, a recommendation server, or any other suitable servers for corresponding functions.

In various embodiments, a terminal involved in the disclosed methods and systems can include the terminal 606, while a server involved in the disclosed methods and systems can include the server 604. The methods and systems disclosed in accordance with various embodiments can be executed by a computer system. In one embodiment, the disclosed methods and systems can be implemented by a server.

Various embodiments provide methods and systems for processing report information. The methods and systems are illustrated in various examples described herein.

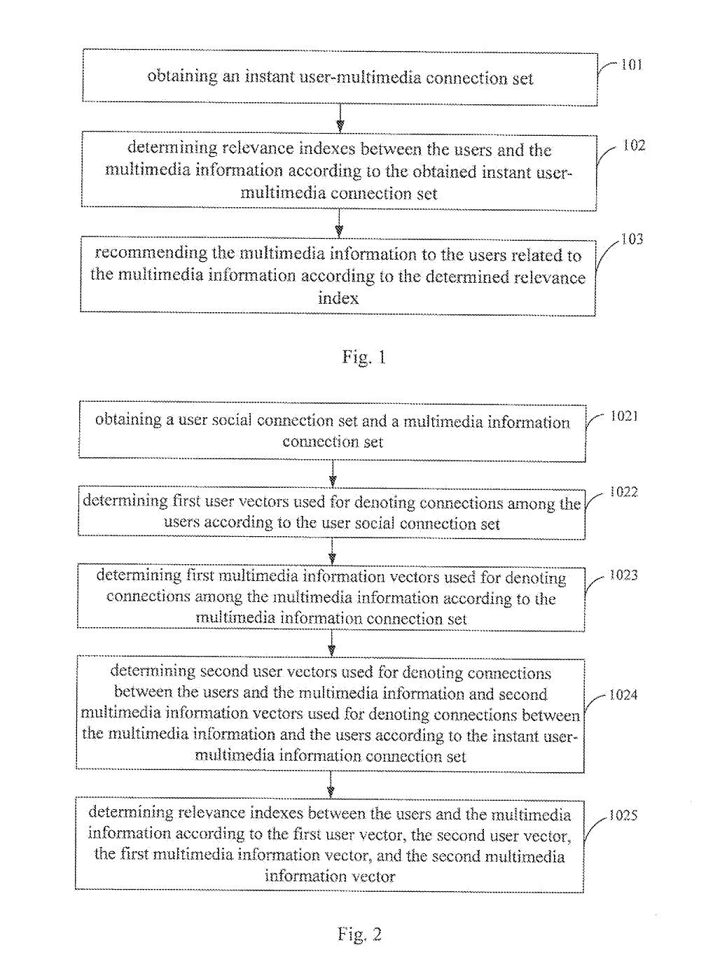

Referring to FIG. 1, it is a flowchart of an example of a method for recommending multimedia information according to various embodiments. The method includes the following steps.

Step S101: obtaining an instant user-multimedia connection set.

Specifically, the instant user-multimedia connection set indicates a connection between users and the multimedia information. In the embodiment, the multimedia information may be videos imported/re-shared by users. The instant user-multimedia connection set is the user-multimedia connection set obtained currently from online social network services (e.g., Facebook. Twitter) and online video sharing services (e.g., YouTube). The instant user-multimedia connection set indicates states of the videos imported/re-shared by the users. The instant user-multimedia connection set may be a matrix. The matrix includes a plurality of entries, arranged in rows and columns. The rows denote the users. The columns denote the videos imported or re-shared by the users. When the entry of the matrix is 1, it denotes that the video corresponding to the entry is imported or re-shared by the user corresponding to the entry. That is, the user corresponding to the entry interests is interested in the imported/re-shared video corresponding to the entry. When the entry of the matrix is 0, it denotes that the video corresponding to the entry fails to be imported or re-shared by the user corresponding to the entry. The instant user-multimedia connection set can be obtained from the social network or video network.

Step S102: determining relevance indexes between the users and the multimedia information according to the obtained instant user-multimedia connection set.

Step S103: recommending the multimedia information to the users related to the multimedia information according to the determined relevance index.

Specifically, the predetermined number of the multimedia information is recommended to the users. The relevance indexes between the predetermined number of the multimedia information and the corresponding users are the greatest of all. The multimedia information is recommended in the form of a list. The list includes an imported multimedia list and a re-shared multimedia list. The imported multimedia list includes the predetermined number of the multimedia information which may be imported by users. The relevance indexes between the predetermined number of the multimedia information and the corresponding users are the greatest of all. The re-shared multimedia list includes the multimedia information which may be re-shared by a plurality of users and have been re-shared by other users followed by the plurality of users.

Referring to FIG. 2, the step 102 may include the following steps.

Step 1021: obtaining a user social connection set and a multimedia information connection set.

Specifically, the user social connection set indicates social connections among the users in the social network. The multimedia information connection set indicates content similarity connections among the multimedia information in the multimedia information network. In the embodiment, the user social connection set may be a matrix. The matrix includes a plurality of entries, arranged in rows and columns. The rows denote the first users. The columns denote the second users. When an entry of the matrix is 1, it indicates that the second user corresponding to the entry is followed by the first user corresponding to the entry. When the entry of the matrix is 0, it indicates that the second user corresponding to the entry fails to be followed by the first user corresponding to the entry. The user social connection set can be obtained from the social network. The multimedia information connection set may be a matrix. The matrix includes a plurality of entries, arranged in rows and columns. The rows denote the first multimedia information. The columns denote the second multimedia information. When an entry of the matrix is 1, it indicates that a content of the first multimedia information corresponding to the entry is similar to a content of the second multimedia information corresponding to the entry. When the entry of the matrix is 0, it indicates that the content of the first multimedia information corresponding to the entry is not similar to the content of the second multimedia information corresponding to the entry. The multimedia information connection set can be obtained from multimedia information network (such as video network).

Step 1022: determining first user vectors used for denoting connections among the users according to the user social connection set.

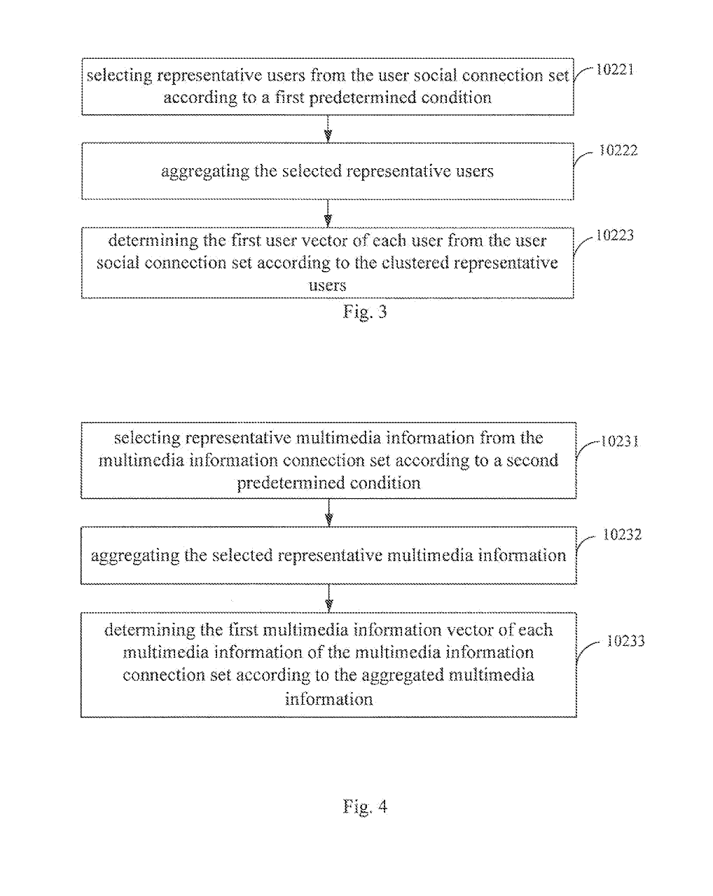

Referring to FIG. 3, the step 1022 may include the following steps.

Step 10221: selecting representative users from the user social connection set according to a first predetermined condition.

In the embodiment, the first predetermined condition may be “famous person”. That is, the representative users needs be selected from the famous persons in the social network, such as Kai-Fu Lee, Ming Yao, Yu Ma and so on. In other embodiments, the first predetermined condition can be changed according to need.

Step 10222: aggregating the selected representative users.

Specifically, the selected representative users can be clustered into K groups according to a first predetermined standard. K is an integer. The first predetermined standard requires the representative users worked on the same filed are clustered into one group. Each group is used as a coordinate axis to form a coordinate system, which is a user space. For example, the selected representative users (Ming Yao, Kai-Fu Lee, and Yun Ma) are clustered into first to third groups. The first group is sports filed group. The second group is computer filed group. The third group is economy filed group. The sports filed group, the computer filed group, and the economy filed group are used as three coordinate axes to form the coordinate system, which is the user space. In the embodiment, the formed coordinate system has three dimensions. In other embodiments, the dimensions of the formed coordinate system can be changed according the number of the groups which the representative users are clustered into. For example, when the representative users are clustered into two groups, the coordinate system has two dimensions. When the representative users are clustered into five groups, the coordinate system has five dimensions.

Step 10223: determining the first user vector of each user from the user social connection set according to the clustered representative users.

Specifically, a coordinate of each user in the formed coordinate system is determined through determining states of each user from the use social connection set following the representative users. The coordinates of the users in the coordinate system are de-normalized entries of the first user vector. The de-normalized entry of the first user vector is defined as fᵢᵤ¹. The entry fᵢᵤ¹ indicates the number of representative user in group i that user u follows. The first user vector is the normalization of vector {f₁ᵤ¹, f₂ᵢᵤ¹, . . . , f_{Ku}¹}. The entry pᵤᵢ of the first user vector is defined as

$${p}_{ui} = \frac{{f}_{iu}^{1}}{{\sum }_{k} {f}_{ku}^{1}} ,$$

wherein k denotes an enumeration of the length of the first user vector; i denotes the sequence number of the entry of the first user vector. The rational of the entry pᵤᵢ is that when user u follows more representative users in a group, the corresponding entry in the first user vector is larger to emphasize his interest in that particular group.

Step 1023: determining first multimedia information vectors used for denoting connections among the multimedia information according to the multimedia information connection set.

Referring to FIG. 4, the step 1023 includes the following steps.

Step 10231: selecting representative multimedia information from the multimedia information connection set according to a second predetermined condition.

In the embodiment, the representative multimedia information may be hot videos. The second predetermined condition may be “hot video”. In the other embodiments, the second predetermined condition can be changed according to need.

Step S10232: aggregating the selected representative multimedia information.

Specifically, the selected representative multimedia information can be clustered into K groups according to the second predetermined standard. K is an integer. The second predetermined standard requires the representative multimedia information with the same character is clustered into one group. Each group is used as a coordinate axis to form a coordinate system, which is a multimedia information space. For example, the selected representative hot videos are clustered into first to third groups. The first group is a current news group. The second group is an entertainment news group. The third group is a sports news group. The current news group, the entertainment news group, and the sports group are used as three coordinate axes to form a coordinate system, which is a multimedia information space. In other embodiments, the dimensions of the formed coordinate system can be changed according the number of the groups which the representative users are clustered into. For example, when the representative multimedia information is clustered into two groups, the coordinate system has two dimensions. When the representative multimedia information is clustered into five groups, the coordinate system has five dimensions.

Step 10233: determining the first multimedia information vector of the each multimedia information of the multimedia information connection set according to the aggregated multimedia information.

Specifically, a coordinate of the each multimedia information in the formed coordinate system is determined through determining states of the each multimedia information from the multimedia information connection set similar to the representative multimedia information. The coordinates of the multimedia information in the coordinate system are de-normalized entries of the first multimedia information vector. The de-normalized entry of the first multimedia information vector is defined as fᵢᵤ³. The entry fᵢᵤ³ denotes the aggregate similarity of the multimedia information c in group i. The first multimedia information vector in the multimedia information space is the normalization of vector {f_{1c}³, f_{2c}³, . . . , f_{Kc}³}. The entry q_{ci} of the first multimedia information vector is defined as

$${q}_{ci} = \frac{{f}_{1 c}^{3}}{{\sum }_{k} {f}_{kc}^{3}} ,$$

wherein k denotes an enumeration of the length of the first multimedia information vector; i denotes the sequence number of the entry of the first multimedia information vector. The rational of the entry q_{ci} is that a larger entry q_{ci} in the first multimedia information vector indicates that the multimedia information c is more similar to that group i.

Step 1024: determining second user vectors used for denoting connections between the users and the multimedia information and second multimedia information vectors used for denoting connections between the multimedia information and the users according to the instant user-multimedia information connection set.

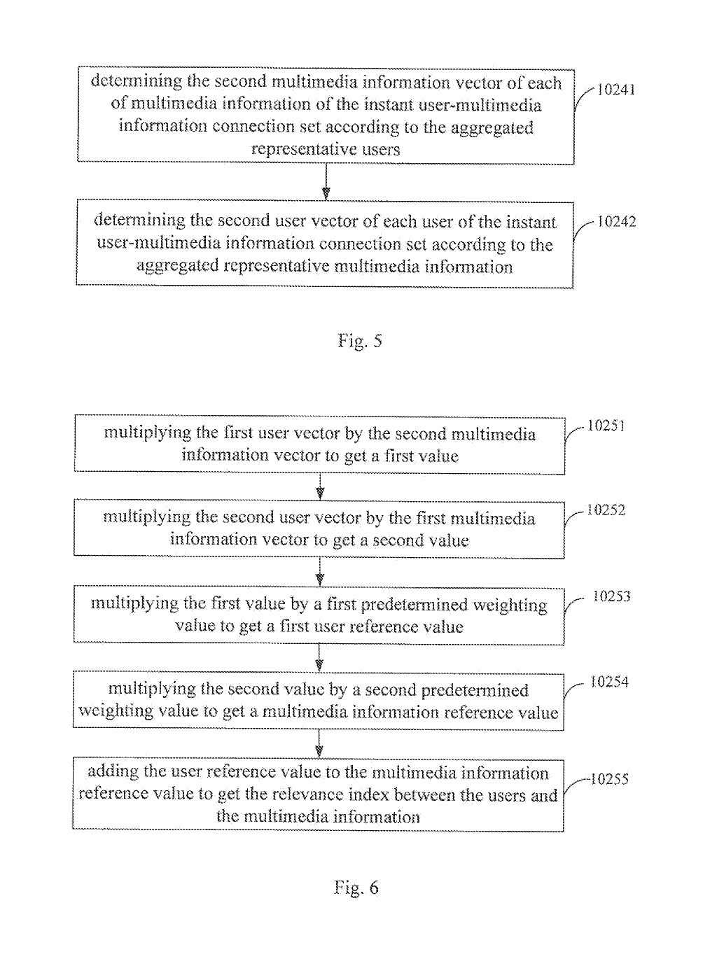

Referring to FIG. 5, the step 1024 may include the following steps.

Step 10241: determining the second multimedia information vector of each of multimedia information of the instant user-multimedia information connection set according to the aggregated representative users.

Specifically, in the instant user-multimedia information connection set, each of multimedia information corresponds to a plurality of users. Let f_{ic}² denote the aggregate strength of users who have imported/re-shared multimedia information c. The second multimedia information vector in user space is defined as the normalization of vector {f_{1c}², f_{2c}², . . . , f_{Kc}²}. The entry p_{ci} of the second multimedia information vector in the user space is defined as

$${p}_{ci} = \frac{{f}_{1 c}^{2}}{{\sum }_{k} {f}_{kc}^{2}} ,$$

wherein k denotes an enumeration of the length of the second multimedia information vector; i denotes the sequence number of the entry of the second multimedia information vector. The rational of the entry q_{ci} is that a larger entry q_{ci} in the second multimedia information vector indicates that more users from the corresponding group i like that multimedia information c. The second multimedia information vector is used to describe the character of the multimedia information through the aggregated representative users, which indicates whether the multimedia information will be welcome in the user groups.

Step S10242: determining the second user vector of each user of the instant user-multimedia information connection set according to the aggregated representative multimedia information.

Specifically, in the instant user-multimedia information connection set, each user corresponds to a plurality of multimedia information. Let fᵤᵢ⁴ denote the aggregate strength of the multimedia information which has been imported/re-shared by user u. The second user vector in the multimedia information space is defined as the normalization of vector {fᵤ₁⁴, fᵤ₂⁴, . . . , fᵤₖ⁴}. The entry qᵤᵢ of the second user vector is defined as

$${q}_{ui} = \frac{{f}_{ui}^{4}}{{\sum }_{k} {f}_{uk}^{4}} ,$$

wherein k denotes an enumeration of the length of the second user vector; i denotes the sequence number of the entry of the second user vector. The rational of the entry qᵤᵢ is that if user u has imported/re-shared more videos similar to a group, the corresponding entry in the second user vector should be larger to reflect his interest in that group. The second user vector indicates the states of the users' preference for the different multimedia information groups.

Step 1025: determining relevance indexes between the users and the multimedia information according to the first user vector, the second user vector, the first multimedia information vector, and the second multimedia information vector.

Referring to FIG. 6, the step 1025 may includes the following steps.

Step 10251: multiplying the first user vector by the second multimedia information vector to get a first value.

Specifically, the first value is equal to p1·q2, wherein p1 is defined as the first user vector; q2 is defined as the second multimedia information vector.

Step 10252: multiplying the second user vector by the first multimedia information vector to get a second value.

Specifically, the second value is equal to p2·q1, wherein p2 is defined as the second user vector; q1 is defined as the first multimedia information vector.

Step 10253: multiplying the first value by a first predetermined weighting value to get a first user reference value.

Specifically, the first user reference value is equal to a·p1·q2, wherein, a is defined as the first predetermined weighting value; p1 is defined as the first user vector, q2 is defined as the second multimedia information vector.

Step 10254: multiplying the second value by a second predetermined weighting value to get a multimedia information reference value.

Specifically, the multimedia information reference value is equal to (1-a)p2·q1, wherein (1−a) is defined as the second predetermined weighting value; p2 is defined as the second user vector; q1 is defined as the first multimedia information vector.

Step 10255: adding the user reference value to the multimedia information reference value to get the relevance index between the users and the multimedia information. The first predetermined weighting value plus the second predetermined weighting value makes one.

Specifically, the relevance index between the users and the multimedia information is equal to a·p1·q2+(1−a)p2·q1. When the imported multimedia information is recommended to a group of the users, the group of the users will pay more attention to the content of the multimedia information. Therefore, the first weighting value may be set less. When the re-shared multimedia information is recommended to a group of the users, not only the content of the multimedia information needs to be considered, but also the users who import or re-shared the corresponding multimedia information and have a social connection with the group of the users need to be considered. Therefore, the first weighting value needs to be set larger.

In the embodiment, the method for recommending multimedia information can obtain the instant user-multimedia information connection set, determine the relevance indexes between the users and the multimedia information according to the obtained instant user-multimedia information connection set. The method further can recommend the multimedia information to the corresponding users related to the multimedia information according to the relevance index between the users and the multimedia information. Therefore, the method for recommending the multimedia information to the corresponding user is base on joint user social connection and the multimedia information similarity, not only base on user social connection or the multimedia information similarity. Therefore, the recommended multimedia information for the group of the users may meet the group of the users' favorite, which improves an accuracy of multimedia information recommendation.

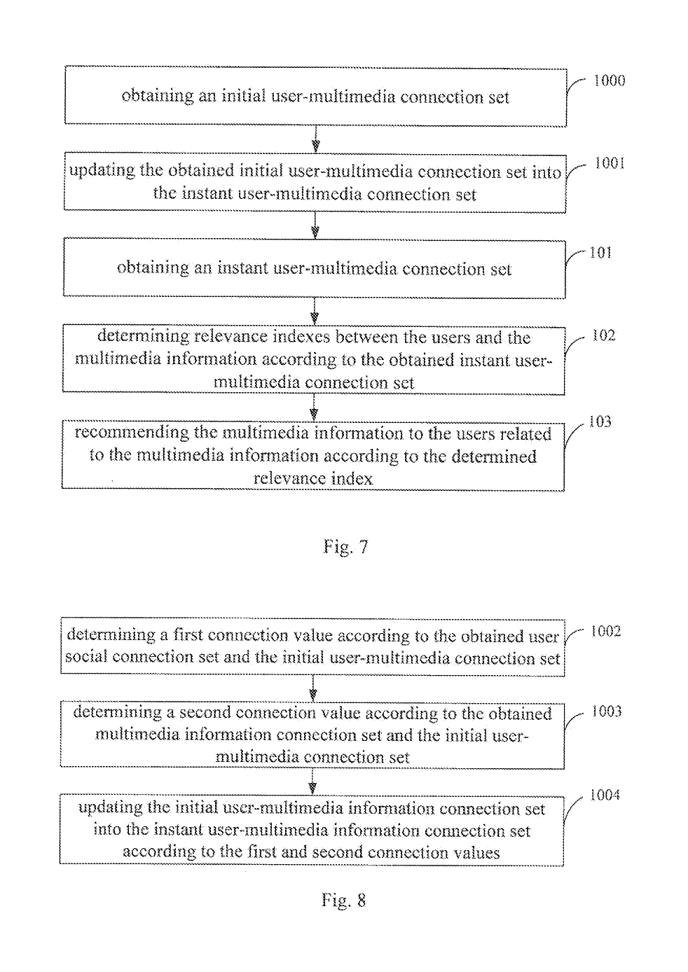

Referring to FIG. 7, it is a flowchart of another example of a method for recommending multimedia information according to various embodiments. The method is similar to the above-mentioned examples of the method for recommending multimedia information. In the embodiment, the method further includes the following steps before the step 101.

Step 1000: obtaining an initial user-multimedia connection set.

Specifically, the initial user-multimedia connection aggregate is the user-multimedia connection aggregate obtained before obtaining the instant user-multimedia connection set. The instant user-multimedia connection set is updated to get the initial user-multimedia connection set.

Step 1001: updating the obtained initial user-multimedia connection set into the instant user-multimedia connection set.

Specifically, the step 1001 may include the following steps.

Obtaining a user social connection set and a multimedia information connection set.

Updating the initial user-multimedia connection set into the instant user-multimedia connection set according to the obtained user social connection set, the multimedia information connection set, and the initial user-multimedia connection set.

Referring to FIG. 8, the step of updating the initial user-multimedia connection set into the instant user-multimedia connection set according to the obtained user social connection set, the multimedia information connection set, and the initial user-multimedia connection set may includes the following steps.

Step 1002: determining a first connection value according to the obtained user social connection set and the initial user-multimedia connection set.

In the embodiment, the first connection value may be defined as

$${I}_{uc}^{T} = {\sum }_{k / {Ω ( {B}^{F - 1} )}_{kc = 1}} {A}_{uk} {B}_{kc}^{( T - 1 )} ,$$

wherein A^{uk} is a row vector; B_{kc}^{(T-1)} is a column vector. The row vector Aᵤₖ indicates the people who are followed by the user u in the user social connection set. The column vector B_{kc}^{(T-1)} denotes the users who have shown interest in video c by importing/re-sharing it in the initial user-multimedia information connection set. Therefore, the first connection value reflects the ability of the content of the multimedia information c interest the user u according to the user social connection. The greater the first connection value is, the more the user u interests in the multimedia information c, because the user u has browsed the multimedia information c.

Step 1003: determining a second connection value according to the obtained multimedia information connection set and the initial user-multimedia connection set.

In the embodiment, the second connection value may be defined as

$${J}_{uc}^{T} = {\sum }_{k / {Ω ( {B}^{T - 1} )}_{uk = 1}} {B}_{uk}^{( T - 1 )} {C}_{kc} ,$$

wherein Bᵤₖ^{(T-1)} is a row vector; C_{kc} is a column vector. The column vector C_{kc} indicates a multimedia information entry similar to the multimedia information c in the multimedia information connection set. The column vector B_{kc}^{(T-1)} denotes the users who have shown interest in video c by importing/re-sharing it in the initial user-multimedia information connection set. Therefore, the second connection value reflects the ability that a content of the multimedia information c interest user u.

Step 1004: updating the initial user-multimedia information connection set into the instant user-multimedia information connection set according to the first and second connection values.

Specifically, the entries of the initial user-multimedia information are updated to make the initial user-multimedia information connection set be updated into the instant user-multimedia information connection set. When the first and second connection value reach to a predetermined value, the initial user-multimedia information connection set will be updated into the instant user-multimedia information connection set. In detail, when that the first connection value multiplied by the second connection value equals to is greater than the predetermined value, the entry “0” corresponding to the first and second connection values is updated into the entry “1”. Therefore, the initial user-multimedia information connection set is updated into the instant user-multimedia information connection set. When that the first connection value multiplied by the second connection value equal to is less than the predetermined value, the entry “0” is not changed.

In the embodiment, the method for recommending multimedia information can obtain the instant user-multimedia information connection set, determine the relevance indexes between the users and the multimedia information according to the obtained instant user-multimedia information connection set. The method further can recommend the multimedia information to the corresponding users related to the multimedia information according to the relevance indexes between the users and the multimedia information. Therefore, the method for recommending the multimedia information to the corresponding user is base on joint user social connection and the multimedia information similarity, not only base on user social connection or the multimedia information similarity. Therefore, the multimedia information recommended to the group of the users may meet the group of the users' favorite, which improves an accuracy of multimedia information recommendation.

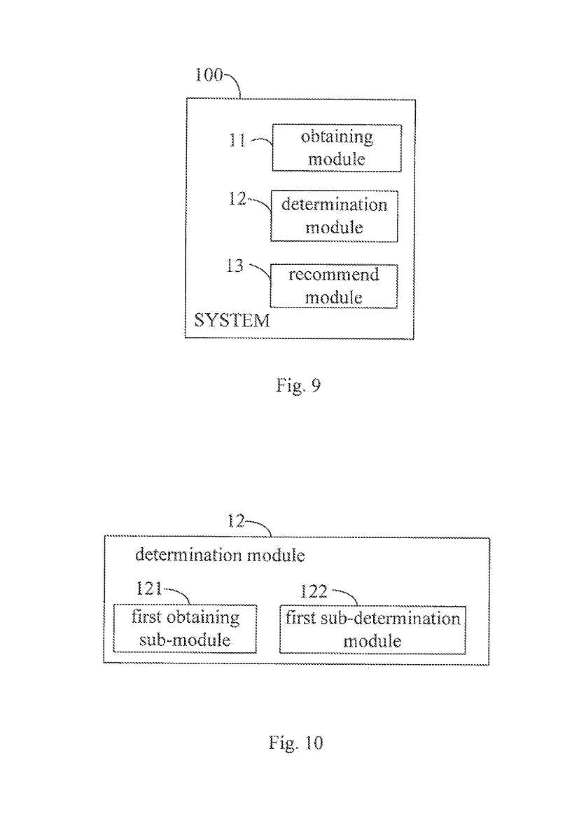

Referring to FIG. 9, it is a block diagram of a system 100 for recommending multimedia information according to various embodiments. The system 100 includes an obtaining module 11, a determination module 12, and a recommend module 13.

The obtaining module 11 is used to obtain an instant user-multimedia connection set.

Specifically, the instant user-multimedia connection set indicates a connection between users and the multimedia information. In the embodiment, the multimedia information may be videos imported/re-shared by users. The instant user-multimedia connection set is the user-multimedia connection set obtained currently from online social network services (e.g., Facebook, Twitter) and online video sharing services (e.g., YouTube). The instant user-multimedia connection set indicates states of the videos imported/re-shared by the users. The instant user-multimedia connection set may be a matrix. The matrix includes a plurality of entries, arranged in rows and columns. The rows denote the users. The columns denote the videos imported or re-shared by the users. When the entry of the matrix is 1, it denotes that the video corresponding to the entry is imported or re-shared by the user corresponding to the entry. That is, the user corresponding to the entry interests is interested in the imported/re-shared video corresponding to the entry. When the entry of the matrix is 0, it denotes that the video corresponding to the entry fails to be imported or re-shared by the user corresponding to the entry. The instant user-multimedia connection set can be obtained from the social network or video network.

The determination module 12 is used to determine relevance indexes between the users and the multimedia information according to the obtained instant user-multimedia connection set.

The recommend module 13 is used to recommend the multimedia information to the users related to the multimedia information according to the determined relevance indexes.

Specifically, the predetermined number of the multimedia information is recommended to the users. The relevance indexes between the predetermined number of the multimedia information and the corresponding users are the greatest of all. The multimedia information is recommended in the form of a list. The list includes an imported multimedia list and a re-shared multimedia list. The imported multimedia list includes the predetermined number of the multimedia information which may be imported by users. The relevance indexes between the predetermined number of the multimedia information and the corresponding users are the greatest of all. The re-shared multimedia list includes the multimedia information which may be re-shared by a plurality of users and have been re-shared by other users followed by the plurality of users.

Referring to FIG. 10, the determination module 12 includes a first obtaining sub-module 121 and a first sub-determination module 122.

The first obtaining sub-module 121 is used to obtain a user social connection set and a multimedia information connection set.

Specifically, the user social connection set indicates social connections among the users in the social network. The multimedia information connection set indicates content similarity connections among the multimedia information in the multimedia information network. In the embodiment, the user social connection set may be a matrix. The matrix includes a plurality of entries, arranged in rows and columns. The rows denote the first users. The columns denote the second users. When an entry of the matrix is 1, it indicates that the second user corresponding to the entry is followed by the first user corresponding to the entry. When the entry of the matrix is 0, it indicates that the second user corresponding to the entry fails to be followed by the first user corresponding to the entry. The user social connection set can be obtained from the social network. The multimedia information connection set may be a matrix. The matrix includes a plurality of entries, arranged in rows and columns. The rows denote the first multimedia information. The columns denote the second multimedia information. When an entry of the matrix is 1, it indicates that a content of the first multimedia information corresponding to the entry is similar to a content of the second multimedia information corresponding to the entry. When the entry of the matrix is 0, it indicates that the content of the first multimedia information corresponding to the entry is not similar to the content of the second multimedia information corresponding to the entry. The multimedia information connection set can be obtained from multimedia information network (such as video network).

The first determination unit 122 is used to determine first user vectors used for denoting connections among the users according to the user social connection set; determine first multimedia information vectors used for denoting connections among the multimedia information according to the multimedia information connection set; determine second user vectors used for denoting connections between the users and the multimedia information and second multimedia information vectors used for denoting connections between the multimedia information and the users according to the instant user-multimedia information connection set; determine relevance indexes between the users and the multimedia information according to the first user vector, the second user vector, the first multimedia information vector, and the second multimedia information vector.

Referring to FIG. 11, the first determination sub-module module 122 includes a selecting unit 1221, an aggregation unit 1222, and a first determination unit 1223.

The selecting unit 1221 is used to select representative users from the user social connection set according to a first predetermined condition.

In the embodiment, the first predetermined condition may be “famous person”. That is, the representative users needs be selected from the famous persons in the social network, such as Kai-Fu Lee, Ming Yao, Yu Ma and so on. In other embodiments, the first predetermined condition can be changed according to need.

The selecting unit 1221 is also used to select representative multimedia information from the multimedia information connection set according to a second predetermined condition.

In the embodiment, the representative multimedia information may be hot videos. The second predetermined condition may be “hot video”. In the other embodiments, the second predetermined condition can be changed according to need.

The aggregation unit 1222 is used to aggregate the selected representative users.

Specifically, the selected representative users can be clustered into K groups according to a first predetermined standard. K is an integer. The first predetermined standard requires the representative users worked on the same filed are clustered into one group. Each group is used as a coordinate axis to form a coordinate system, which is a user space. For example, the selected representative users (Ming Yao, Kai-Fu Lee, and Yun Ma) are clustered into first to third groups. The first group is sports filed group. The second group is computer filed group. The third group is economy filed group. The sports filed group, the computer filed group, and the economy filed group are used as three coordinate axes to form the coordinate system, which is the user space.

The aggregation unit 1222 is also used to aggregate the selected representative multimedia information.

In the embodiment, the formed coordinate system has three dimensions. In other embodiments, the dimensions of the formed coordinate system can be changed according the number of the groups which the representative users are clustered into. For example, when the representative users are clustered into two groups, the coordinate system has two dimensions. When the representative users are clustered into five groups, the coordinate system has five dimensions.

Specifically, the selected representative multimedia information can be clustered into K groups according to the second predetermined standard. K is an integer. The second predetermined standard requires the representative multimedia information with the same character is clustered into one group. Each group is used as a coordinate axis to form a coordinate system, which is a multimedia information space. For example, the selected representative hot videos are clustered into first to third groups. The first group is a current news group. The second group is an entertainment news group. The third group is a sports news group. The current news group, the entertainment news group, and the sports group are used as three coordinate axes to form a coordinate system, which is a multimedia information space. In other embodiments, the dimensions of the formed coordinate system can be changed according the number of the groups which the representative users are clustered into. For example, when the representative multimedia information is clustered into two groups, the coordinate system has two dimensions. When the representative multimedia information is clustered into five groups, the coordinate system has five dimensions.

The first determination unit 1223 is used to determine the first user vector of each user from the user social connection set according to the clustered representative users.

Specifically, a coordinate of each user in the formed coordinate system is determined through determining states of each user from the use social connection set following the representative users. The coordinates of the users in the coordinate system are de-normalized entries of the first user vector. The de-normalized entry of the first user vector is defined as fᵢᵤ¹. The entry fᵢᵤ¹ indicates the number of representative user in group i that user u follows. The first user vector is the normalization of vector {f₁ᵤ¹, f₂ᵢᵤ¹, . . . , f_{Ku}¹}. The entry pᵤᵢ of the first user vector is defined as

$${p}_{ui} = \frac{{f}_{iu}^{1}}{{\sum }_{k} {f}_{ku}^{1}} ,$$

wherein k denotes an enumeration of the length of the first user vector; i denotes the sequence number of the entry of the first user vector. The rational of the entry pᵤᵢ is that when user u follows more representative users in a group, the corresponding entry in the first user vector is larger to emphasize his interest in that particular group.

The first determination unit 1223 is also used to determine the first multimedia information vector of the each multimedia information of the multimedia information connection set according to the aggregated multimedia information.

Specifically, a coordinate of the each multimedia information in the formed coordinate system is determined through determining states of the each multimedia information from the multimedia information connection set similar to the representative multimedia information. The coordinates of the multimedia information in the coordinate system are de-normalized entries of the first multimedia information vector. The de-normalized entry of the first multimedia information vector is defined as f_{ic}³. The entry f_{ic}³ denotes the aggregate similarity of the multimedia information c in group i. The first multimedia information vector in the multimedia information space is the normalization of vector {f_{1c}³, f_{2c}³, . . . , f_{Kc}³}. The entry q_{ci} of the first multimedia information vector is defined as

$${q}_{ci} = \frac{{f}_{1 c}^{3}}{{\sum }_{k} {f}_{kc}^{3}} ,$$

wherein k denotes an enumeration of the length of the first multimedia information vector; i denotes the sequence number of the entry of the first multimedia information vector. The rational of the entry q_{ci} is that a larger entry q_{ci} in the first multimedia information vector indicates that the multimedia information c is more similar to that group i.

The first determination unit 1223 is also used to determine the second multimedia information vector of each of multimedia information of the instant user-multimedia information connection set according to the aggregated representative users.

Specifically, in the instant user-multimedia information connection set, each of multimedia information corresponds to a plurality of users. Let f_{ic}² denote the aggregate strength of users who have imported/re-shared multimedia information c. The second multimedia information vector in user space is defined as the normalization of vector {f_{1c}², f_{2c}², . . . , f_{Kc}²}. The entry p_{ci} of the second multimedia information vector in the user space is defined as

$${p}_{ci} = \frac{{f}_{ic}^{2}}{{\sum }_{k} {f}_{kc}^{2}} ,$$

wherein k denotes an enumeration of the length of the second multimedia information vector; i denotes the sequence number of the entry of the second multimedia information vector. The rational of the entry q_{ci} is that a larger entry q_{ci} in the second multimedia information vector indicates that more users from the corresponding group i like that multimedia information c. The second multimedia information vector is used to describe the character of the multimedia information through the aggregated representative users, which indicates whether the multimedia information will be welcome in the user groups.

The first determination unit 1223 is also used to determining the second user vector of each user of the instant user-multimedia information connection set according to the aggregated representative multimedia information.

Specifically, in the instant user-multimedia information connection set, each user corresponds to a plurality of multimedia information. Let fᵤᵢ⁴ denote the aggregate strength of the multimedia information which has been imported/re-shared by user u. The second user vector in the multimedia information space is defined as the normalization of vector {fᵤ₁⁴, fᵤ₂⁴, . . . , fᵤₖ⁴}. The entry qᵤᵢ of the second user vector is defined as

$${q}_{ui} = \frac{{f}_{ui}^{4}}{{\sum }_{k} {f}_{uk}^{4}} ,$$

wherein k denotes an enumeration of the length of the second user vector; i denotes the sequence number of the entry of the second user vector. The rational of the entry qᵤᵢ is that if user u has imported/re-shared more videos similar to a group, the corresponding entry in the second user vector should be larger to reflect his interest in that group. The second user vector indicates the states of the users' preference for the different multimedia information groups.

The first determination sub-module 122 further includes a multiplication unit 1224 and an addition unit 1225.

The multiplication unit 1224 is used to multiply the first user vector by the second multimedia information vector to get a first value.

Specifically, the first value is equal to p1·q2, wherein p1 is defined as the first user vector; q2 is defined as the second multimedia information vector.

The multiplication unit 1224 is also used to multiply the second user vector by the first multimedia information vector to get a second value.

Specifically, the second value is equal to p2·q1, wherein p2 is defined as the second user vector; q1 is defined as the first multimedia information vector.

The multiplication unit 1224 is also used to multiply the first value by a first predetermined weighting value to get a first user reference value.

Specifically, the first user reference value is equal to a·p1·q2, wherein, a is defined as the first predetermined weighting value; p1 is defined as the first user vector, q2 is defined as the second multimedia information vector.

The multiplication unit 1224 is also used to multiply the second value by a second predetermined weighting value to get a multimedia information reference value.

Specifically, the multimedia information reference value is equal to (1−a)p2·q1, wherein (1−a) is defined as the second predetermined weighting value; p2 is defined as the second user vector; q1 is defined as the first multimedia information vector.

The addition unit 1225 is used to add the user reference value to the multimedia information reference value to get the relevance index between the users and the multimedia information. The first predetermined weighting value plus the second predetermined weighting value makes one.

Specifically, the relevance index between the users and the multimedia information is equal to a·p1·q2+(1−a)p2·q1. When the imported multimedia information is recommended to a group of the users, the group of the users will pay more attention to the content of the multimedia information. Therefore, the first weighting value may be set less. When the re-shared multimedia information is recommended to a group of the users, not only the content of the multimedia information needs to be considered, but also the users who import or re-shared the corresponding multimedia information and have a social connection with the group of the users need to be considered. Therefore, the first weighting value needs to be set larger.

In the embodiment, the system 100 includes the obtaining module 11, the determination module 12, and the recommend module 13. The obtaining module 11 is used to obtain the instant user-multimedia information connection set. The determination module 12 is used to determine the relevance indexes between the users and the multimedia information according to the obtained instant user-multimedia information connection set. The recommend unit 13 is used to recommend the multimedia information to the corresponding users related to the multimedia information according to the relevance index between the users and the multimedia information. Therefore, the system for recommending the multimedia information to the corresponding user is base on joint user social connection and the multimedia information similarity, not only base on user social connection or the multimedia information similarity. Therefore, the recommended multimedia information for the group of the users may meet the group of the users' favorite, which improves an accuracy of multimedia information recommendation.

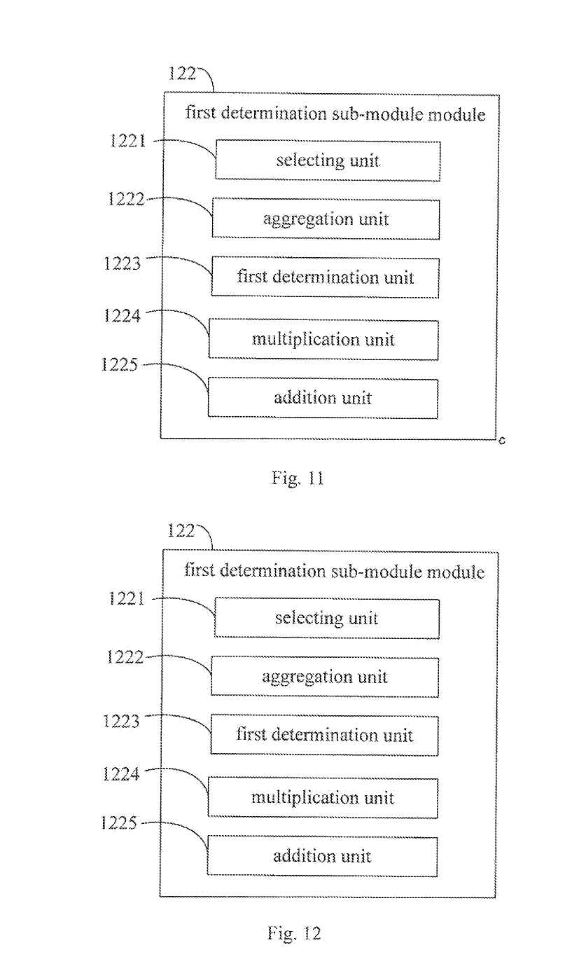

Referring to FIG. 12, it is a block diagram of another example of a system 200 for recommending multimedia information according to various embodiments. The system 200 is similar to the above-mentioned examples of the system 100 for recommending multimedia information. In the embodiment, the system 200 further includes the update module 14.

The obtaining module 11 is further used to obtain an initial user-multimedia connection set.

Specifically, the initial user-multimedia connection aggregate is the user-multimedia connection aggregate obtained before obtaining the instant user-multimedia connection set. The instant user-multimedia connection set is updated to get the initial user-multimedia connection set.

The update module 14 is used to update the obtained initial user-multimedia connection set into the instant user-multimedia connection set.

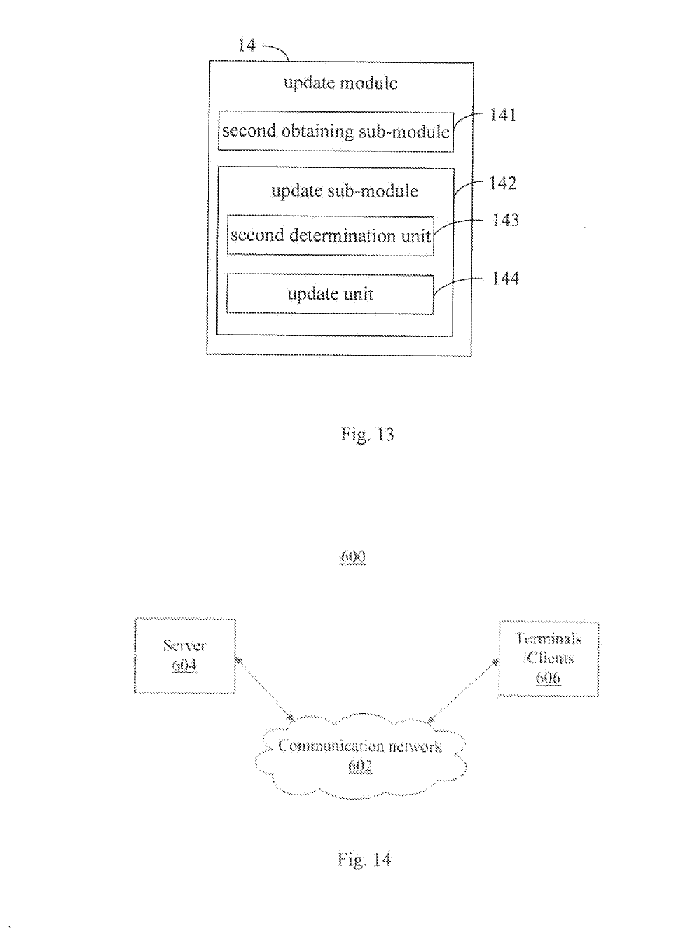

Referring to FIG. 13, the update module 14 includes a second obtaining sub-module 141 and an update sub-module 142.

The second obtain sub-module 141 is used to obtain a user social connection set and a multimedia information connection set.

The update sub-module 142 is used to update the initial user-multimedia connection set into the instant user-multimedia connection set according to the obtained user social connection set, the multimedia information connection set, and the initial user-multimedia connection set.

Further, the update sub-module 142 includes a second determination unit 143 and update unit 144.

The second determination unit 143 is used to determine a first connection value according to the obtained user social connection set and the initial user-multimedia connection set.

In the embodiment, the first connection value may be defined as

$${I}_{uc}^{T} = {\sum }_{k / {Ω ( {B}^{T - 1} )}_{kc = 1}} {A}_{uk} {B}_{kc}^{( T - 1 )} ,$$

wherein Aᵤₖ is a row vector: B_{kc}^{(T-1)} is a column vector. The row vector Aᵤₖ indicates the people who are followed by the user u in the user social connection set. The column vector B_{kc}^{(T-1)} denotes the users who have shown interest in video c by importing/re-sharing it in the initial user-multimedia information connection set. Therefore, the first connection value reflects the ability of the content of the multimedia information c interest the user u according to the user social connection. The greater the first connection value is, the more the user u interests in the multimedia information c, because the user u has been browsed the multimedia information c.

The second determination unit 143 is also used to determine a second connection value according to the obtained multimedia information connection set and the initial user-multimedia connection set.

The update unit 144 is also used to update the initial user-multimedia information connection set into the instant user-multimedia information connection set according to the first and second connection values.

Specifically, the entries of the initial user-multimedia information are updated to make the initial user-multimedia information connection set be updated into the instant user-multimedia information connection set. When the first and second connection value reach to a predetermined value, the initial user-multimedia information connection set will be updated into the instant user-multimedia information connection set. In detail, when that the first connection value multiplied by the second connection value equals to is greater than the predetermined value, the entry “0” corresponding to the first and second connection values is updated into the entry “1”. Therefore, the initial user-multimedia information connection set is updated into the instant user-multimedia information connection set. When that the first connection value multiplied by the second connection value equal to is less than the predetermined value, the entry “0” is not changed.

In the embodiment, the system for recommending multimedia information includes the obtaining module 11, the determination module 12, and the recommend module 13. The obtaining module 11 is used to obtain the instant user-multimedia information connection set. The determination module 12 is used to determine the relevance indexes between the users and the multimedia information according to the obtained instant user-multimedia information connection set. The recommend unit 13 is used to recommend the multimedia information to the corresponding users related to the multimedia information according to the relevance index between the users and the multimedia information. Therefore, the system for recommending the multimedia information to the corresponding user is base on joint user social connection and the multimedia information similarity, not only base on user social connection or the multimedia information similarity. Therefore, the recommended multimedia information for the group of the users may meet the group of the users' favorite, which improves an accuracy of multimedia information recommendation.

A person having ordinary skills in the art can realize that part or whole of the processes in the methods according to the above embodiments may be implemented by a computer program instructing relevant hardware. The program may be stored in a computer readable storage medium. When executed, the program may execute processes in the above-mentioned embodiments of methods. The storage medium may be a magnetic disk, an optical disk, a Read-Only Memory (ROM), a Random Access Memory (RAM), et al.

The above descriptions are some exemplary embodiments of the invention, and should not be regarded as limitation to the scope of related claims. A person having ordinary skills in a relevant technical field will be able to make improvements and modifications within the spirit of the principle of the invention. The improvements and modifications should also be incorporated in the scope of the claims attached below.

What is claimed is:

1. A method for recommending multimedia information, comprising:
obtaining an instant user-multimedia connection set;
determining relevance indexes between the users and the multimedia information according to the obtained instant user-multimedia connection set;
recommending the multimedia information to the users related to the multimedia information according to the determined relevance index.

2. The method according to claim 1, wherein the determining relevance indexes between the users and the multimedia information according to the obtained instant user-multimedia connection set comprises:
obtaining a user social connection set and a multimedia information connection set;
determining first user vectors configured to denote connections among the users according to the user social connection set;
determining first multimedia information vectors configured to denote connections among the multimedia information according to the multimedia information connection set;
determining second user vectors configured to denote connections between the users and the multimedia information, and second multimedia information vectors configured to denote connections between the multimedia information and the users according to the instant user-multimedia information connection set;
determining relevance indexes between the users and the multimedia information according to the first user vector, the second user vector, the first multimedia information vector, and the second multimedia information vector.

3. The method according to claim 2, wherein the determining first user vectors configured to denote connections among the users according to the user social connection set comprises:
selecting representative users from the user social connection set according to a first predetermined condition;
aggregating the selected representative users;
determining the first user vector of each user from the user social connection set according to the clustered representative users.

4. The method according to claim 3, wherein the determining first multimedia information vectors configured to denote connections among the multimedia information according to the multimedia information connection set comprises:
selecting representative multimedia information from the multimedia information connection set according to a second predetermined condition;
aggregating the selected representative multimedia information;
determining the first multimedia information vector of the each multimedia information of the multimedia information connection set according to the aggregated multimedia information.

5. The method according to claim 4, wherein the determining second user vectors configured to denote connections between the users and the multimedia information, and second multimedia information vectors configured to denote connections between the multimedia information and the users according to the instant user-multimedia information connection set comprises:
determining the second multimedia information vector of each multimedia information of the instant user-multimedia information connection set according to the aggregated representative users;
determining the second user vector of each user of the instant user-multimedia information connection set according to the aggregated representative multimedia information.

6. The method according to claim 5, wherein the determining relevance indexes between the users and the multimedia information according to the first user vector, the second user vector, the first multimedia information vector, and the second multimedia information vector comprises:
multiplying the first user vector by the second multimedia information vector to get a first value;
multiplying the second user vector by the first multimedia information vector to get a second value;
multiplying the first value by a first predetermined weighting value to get a first user reference value;
multiplying the second value by a second predetermined weighting value to get a multimedia information reference value;
adding the user reference value to the multimedia information reference value to get the relevance index between the users and the multimedia information. The first predetermined weighting value plus the second predetermined weighting value makes one.

7. The method according to claim 1, wherein before the obtaining an instant user-multimedia connection set, the method further comprises:
obtaining an initial user-multimedia connection set;
updating the obtained initial user-multimedia connection set into the instant user-multimedia connection set.

8. The method according to claim 7, wherein the updating the obtained initial user-multimedia connection set into the instant user-multimedia connection set comprises:
obtaining a user social connection set and a multimedia information connection set,
updating the initial user-multimedia connection set into the instant user-multimedia connection set according to the obtained user social connection set, the multimedia information connection set, and the initial user-multimedia connection set.

9. The method according to claim 8, wherein the updating the initial user-multimedia connection set into the instant user-multimedia connection set according to the obtained user social connection set, the multimedia information connection set, and the initial user-multimedia connection set comprises:
determining a first connection value according to the obtained user social connection set and the initial user-multimedia connection set;
determining a second connection value according to the obtained multimedia information connection set and the initial user-multimedia connection set;
updating the initial user-multimedia information connection set into the instant user-multimedia information connection set according to the first and second connection values.

10. The method according to claim 9, wherein when the first and second connection value reach to a predetermined value, the initial user-multimedia information connection set will be updated into the instant user-multimedia information connection set.

11. A system for recommending multimedia information comprising:
an obtaining module configured to obtain an instant user-multimedia connection set;
a determination module configured to determine relevance indexes between the users and the multimedia information according to the obtained instant user-multimedia connection set;
a recommend module configured to recommend the multimedia information to the users related to the multimedia information according to the determined relevance indexes.

12. The system according to claim 11, wherein the determination module comprises:
a first obtaining sub-module configured to obtain a user social connection set and a multimedia information connection set;
a first determination unit configured to determine first user vectors configured to denote connections among the users according to the user social connection set; determine first multimedia information vectors configured to denote connections among the multimedia information according to the multimedia information connection set; determine second user vectors configured to denote connections between the users and the multimedia information and second multimedia information vectors configured to denote connections between the multimedia information and the users according to the instant user-multimedia information connection set; determine relevance indexes between the users and the multimedia information according to the first user vector, the second user vector, the first multimedia information vector, and the second multimedia information vector.

13. The system according to claim 12, wherein the first determination sub-module comprises:
a selecting unit configured to select representative users from the user social connection set according to a first predetermined condition;
an aggregation unit configured to aggregate the selected representative users;
a first determination unit configured to determine the first user vector of each user from the user social connection set according to the clustered representative users.

14. The system of claim 13, wherein the selecting unit is further configured to select representative multimedia information from the multimedia information connection set according to a second predetermined condition; the aggregation unit is further configured to aggregate the selected representative multimedia information; the first determination unit is further configured to determine the first multimedia information vector of the each multimedia information of the multimedia information connection set according to the aggregated multimedia information.

15. The system according to claim 14, wherein the first determination unit is further configured to determine the second multimedia information vector of each multimedia information of the instant user-multimedia information connection set according to the aggregated representative users, and further configured to determining the second user vector of each user of the instant user-multimedia information connection set according to the aggregated representative multimedia information.

16. The system according to claim 14, wherein the first determination sub-module comprises:
a multiplication unit configured to multiply the first user vector by the second multimedia information vector to get a first value, multiply the second user vector by the first multimedia information vector to get a second value, multiply the first value by a first predetermined weighting value to get a first user reference value, and multiply the second value by a second predetermined weighting value to get a multimedia information reference value;
an addition unit configured to add the user reference value to the multimedia information reference value to get the relevance index between the users and the multimedia information. The first predetermined weighting value plus the second predetermined weighting value makes one.

17. The system according to claim 11, further comprising a update module, wherein the obtaining module is further configured to obtain an initial user-multimedia connection set, the update module is configured to update the obtained initial user-multimedia connection set into the instant user-multimedia connection set.

18. The system according to claim 17, the update module comprising:
a second obtain sub-module configured to obtain a user social connection set and a multimedia information connection set;
an update sub-module configured to update the initial user-multimedia connection set into the instant user-multimedia connection set according to the obtained user social connection set, the multimedia information connection set, and the initial user-multimedia connection set.

19. The system according to claim 18, wherein the update sub-module comprising:
a second determination unit 143 is used to determine a first connection value according to the obtained user social connection set and the initial user-multimedia connection set, and configured to determine a second connection value according to the obtained multimedia information connection set and the initial user-multimedia connection set;
an update unit configured to update the initial user-multimedia information connection set into the instant user-multimedia information connection set according to the first and second connection values.

20. The system according to claim 19, wherein the update unit is configured to update the initial user-multimedia information connection set into the instant user-multimedia information connection set when the first and second connection value reach to a predetermined value.
